(19) United States
(12) Patent Application Publication
(10) Pub. No.: US 2025/0091422 A1
(43) Pub. Date: Mar. 20, 2025

(54) BOTTOM STRUCTURE OF VEHICLE

(71) Applicant: Honda Motor Co., Ltd., Tokyo (JP)

(72) Inventors: Naoki TANI, Tokyo (JP); Yoshikatsu OTA, Saitama (JP); Ken KATSURAI, Tokyo (JP); Shigeru IBA, Tokyo (JP); Yasuhiko KAWASE, Tokyo (JP)

(73) Assignee: Honda Motor Co., Ltd., Tokyo (JP)

(21) Appl. No.: 18/656,584

(22) Filed: May 6, 2024

(30) Foreign Application Priority Data
Sep. 14, 2023 (CN) 202311186556.X

(51) Int. Cl. B60K 1/04

(52) U.S. Cl. CPC B60K 1/04; B60K 2001/0416

(57) ABSTRACT

A bottom structure of vehicle includes a power unit housing. An upper surface of the power unit housing is formed as a floor surface. The power unit housing includes a front seal portion disposed at a front-end portion as well as a rear seal portion disposed at a rear end portion. The front seal portion and the rear seal portion are disposed at a same height in an up/down direction of vehicle.

### CROSS-REFERENCE TO RELATED APPLICATION

This application claims the priority benefit of China application serial no. 202311186556.X, filed on Sep. 14, 2023. The entirety of the above-mentioned patent application is hereby incorporated by reference herein and made a part of this specification.

### BACKGROUND

### Technical Field

The disclosure relates to a bottom structure of vehicle.

### Description of Related Art

In order to provide a sustainable transportation system for disadvantaged groups such as the elderly, the physically challenged, and children, it is committed to providing transportation with superior vehicle comfort. In the existing technology, it is difficult to completely seal a non-flat surface to prevent water intrusion because the floor part of the bottom structure of vehicle includes structures such as a floor channel and a curved structure such as an incline at the end in the vehicle width direction. The disclosure aims to solve the above-mentioned problem by improving the rideability of a vehicle and providing a sustainable transportation system.

### SUMMARY

A bottom structure of vehicle of the disclosure includes a power unit housing. An upper surface of the power unit housing is formed as a floor surface, and the power unit housing includes a front seal portion disposed at a front-end portion as well as a rear seal portion disposed at a rear end portion. The front seal portion and the rear seal portion are disposed at a same height in an up/down direction of vehicle.

### BRIEF DESCRIPTION OF THE DRAWINGS

FIG. 1 is a schematic top view of a bottom structure of vehicle according to an embodiment of the disclosure.

FIG. 2 is a cross-sectional view of the bottom structure of vehicle of FIG. 1 along a line A-A.

FIG. 3 is a cross-sectional view of the bottom structure of vehicle of FIG. 1 along a line B-B.

FIG. 4A is a cross-sectional view of the bottom structure of vehicle of FIG. 1 along a line C-C.

FIG. 4B is a schematic view of a modified embodiment of FIG. 4A.

FIG. 5 is a partial bottom view of a bottom structure of vehicle according to the embodiment.

FIG. 6 is a cross-sectional view of a power unit housing of FIG. 5 along a line D-D.

FIG. 7 is a cross-sectional view of the power unit housing of FIG. 5 along a line E-E.

FIG. 8 is another partial bottom view of a bottom structure of vehicle according to the embodiment.

### DESCRIPTION OF THE EMBODIMENTS

The disclosure provides a bottom structure of vehicle, capable of well preventing water intrusion.

In an embodiment of the disclosure, the power unit housing further includes a side seal portion disposed at a side end portion. The front seal portion, the side seal portion, and the rear seal portion are continuously connected and formed on a same plane to become a first sealing surface.

In an embodiment of the disclosure, a side panel is formed on a side portion of the power unit housing, the side panel and the first sealing surface are formed in a same plane, and the side seal portion is disposed on the side panel.

In an embodiment of the disclosure, the power unit housing further includes a first storage portion and a second storage portion, the second storage portion is disposed further rearward than the first storage portion in a front/rear direction of vehicle, and an upper surface of the second storage portion is formed to be higher than an upper surface of the first storage portion in the up/down direction of vehicle. The second storage portion includes a flange portion, the flange portion and the first storage portion are disposed at a same height in the up/down direction of vehicle, and the flange portion is joined to the side panel.

In an embodiment of the disclosure, a side sill is disposed on the outside of the side panel in a width direction of vehicle. A bottom of the side sill in the up/down direction of vehicle includes a second sealing surface and a fixing surface. The second sealing surface is located inside relative to the fixing surface in the width direction of vehicle, and at the upper in the up/down direction of vehicle.

In an embodiment of the disclosure, the bottom of the side sill further includes a vertical wall extending in the up/down direction of vehicle to connect the second sealing surface and the fixing surface. A reinforcing component is disposed inside the side sill, and the vertical wall is joined to a lower end portion of the reinforcing component.

In an embodiment of the disclosure, the side panel is formed with a hollow closed cross-section below the side sill in the up/down direction of vehicle, and a lifting member is disposed inside the closed cross-section.

In an embodiment of the disclosure, the fixing surface of the side sill is fixed to the side panel through a fastening member, and the lifting member is disposed close to the fastening member.

In an embodiment of the disclosure, the bottom structure of vehicle further includes a lower front wall panel disposed in front of the power unit housing in a front/rear direction of vehicle; and a front member disposed below the lower front wall panel in the up/down direction of vehicle. The power unit housing is provided with a front fixing portion close to the front seal portion, and the front fixing portion integrally fixes the power unit housing, the lower front wall panel, and the front member.

In an embodiment of the disclosure, the power unit housing further includes a front vertical wall extending from the front of the front seal portion in the front/rear direction of vehicle toward the bottom in the up/down direction of vehicle, the front fixing portion extends from the front vertical wall toward the front in the front/rear direction of vehicle, and the front fixing portion is located below the front member and the lower front wall panel in the up/down direction of vehicle.

In an embodiment of the disclosure, the front fixing portion includes a first front fixing portion and a second front fixing portion. The first front fixing portion is formed at an outer end portion in a width direction of vehicle, and the second front fixing portion is formed at a position away from the first front fixing portion in the width direction of vehicle. A piping member is disposed between the first front fixing portion and the second front fixing portion.

In an embodiment of the disclosure, a rear suspension component is disposed behind the power unit housing in a front/rear direction of vehicle and disposed below in the up/down direction of vehicle. The rear suspension component includes a mounting portion mounted on opposite sides of a vehicle body in a width direction of vehicle. The power unit housing overlaps the mounting portion of the rear suspension component in the width direction of vehicle.

In an embodiment of the disclosure, a rear member is formed behind the power unit housing in the front/rear direction of vehicle, and the rear member extends in the width direction of vehicle. The mounting portion of the rear suspension component and a rear fixing portion formed at the rear of a lower surface of the power unit housing are fixed to the rear member.

Based on the above, in the bottom structure of vehicle of this embodiment, the upper surface of the power unit housing is formed as a floor surface, and thus requires a sealing surface capable of waterproofing to prevent water intrusion. By providing the front seal portion and the rear seal portion with equal heights at the front-end portion and the rear end portion of the power unit housing, it is possible to avoid a situation in which it is difficult to seal the power unit housing during assembly due to unequal heights in the front/rear direction. Accordingly, the bottom structure of vehicle of the embodiment is capable of well preventing water intrusion.

To make the aforementioned more comprehensible, several embodiments accompanied with drawings are described in detail as follows.

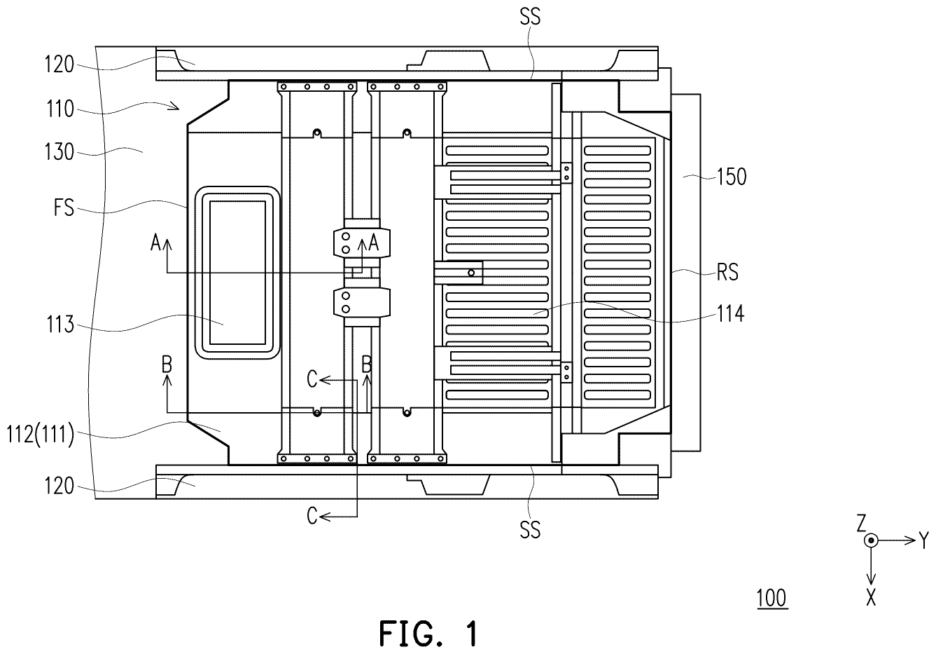

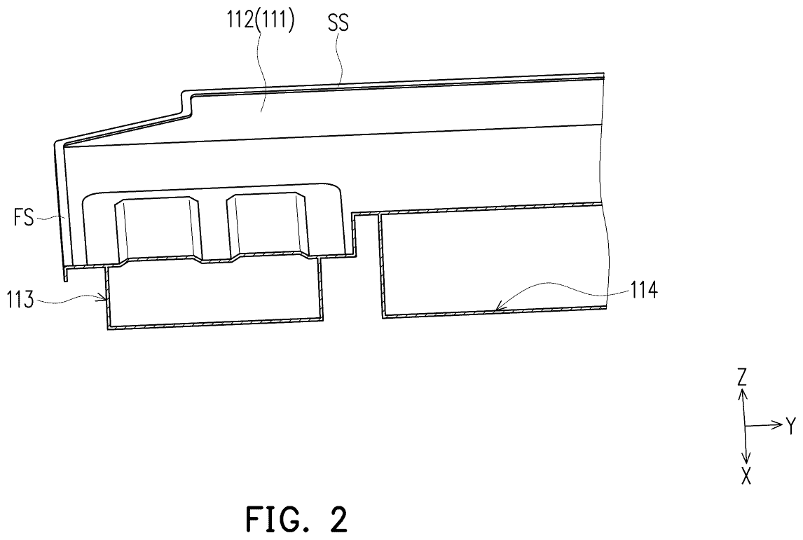

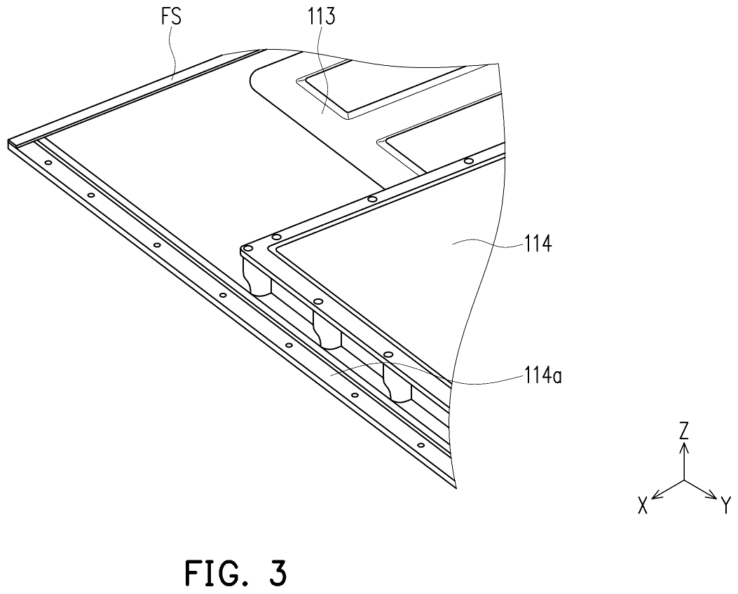

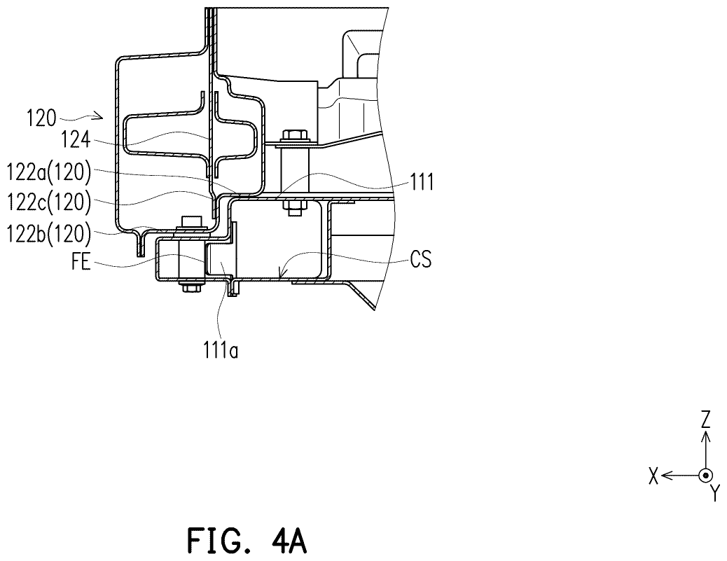

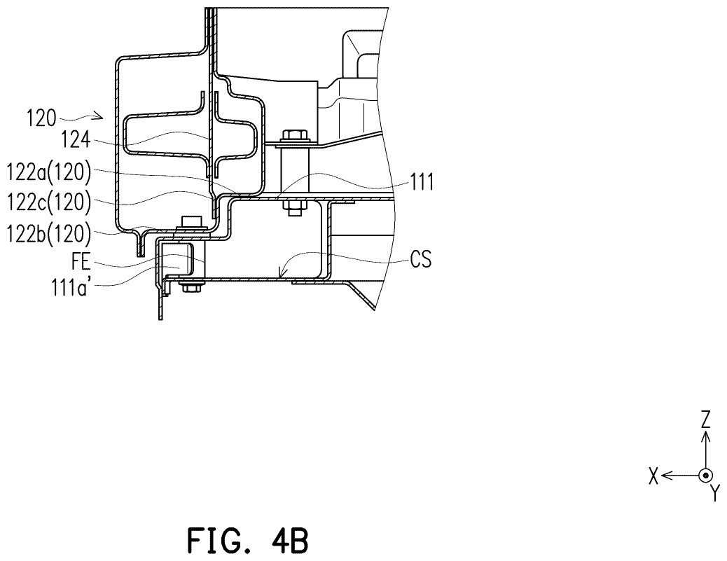

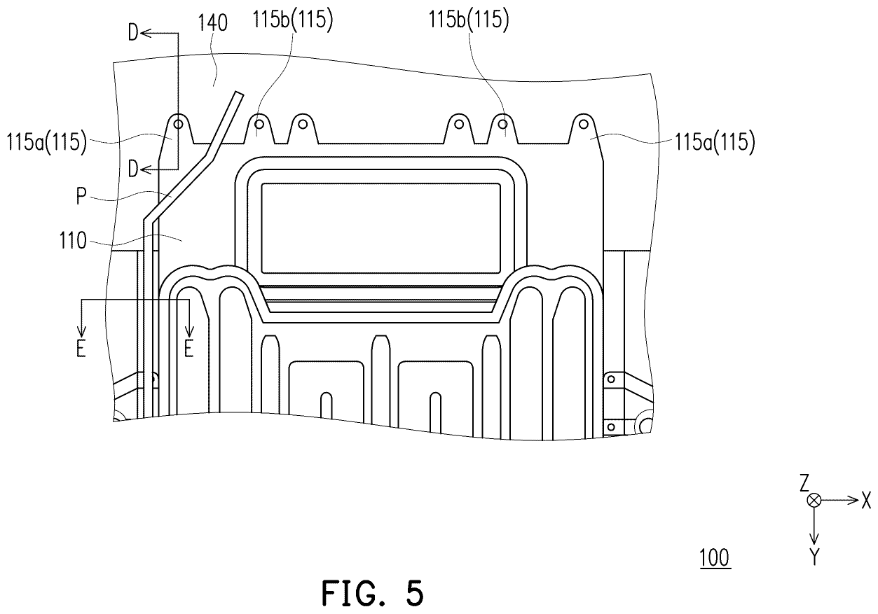

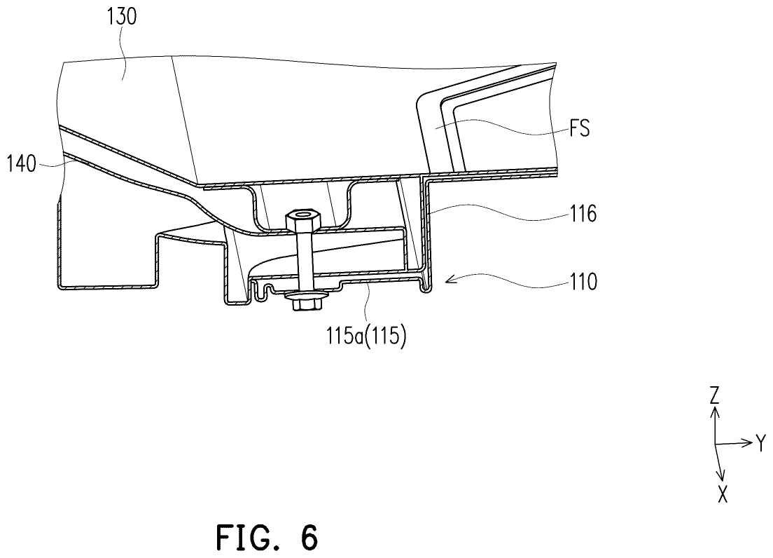

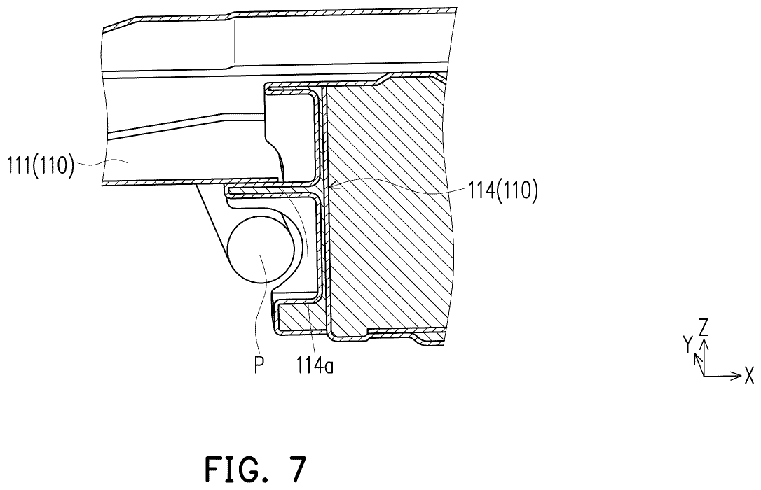

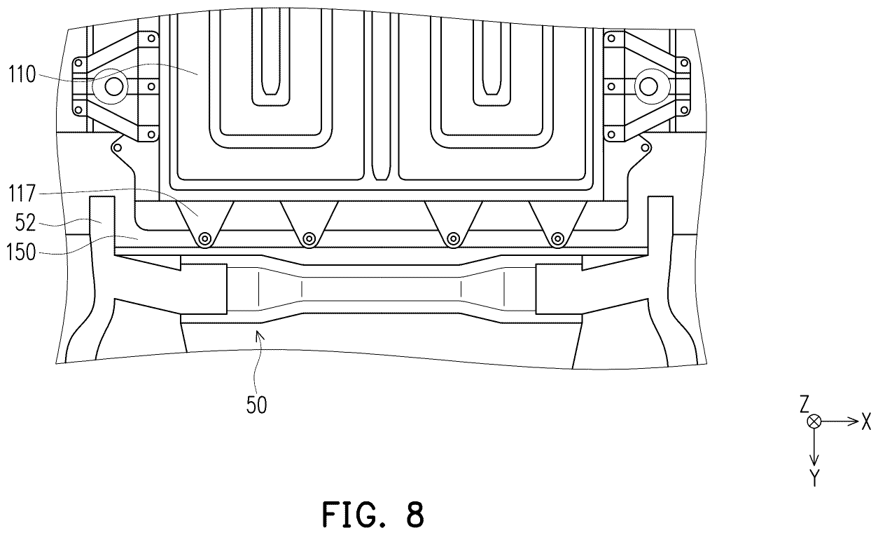

FIG. 1 is a schematic top view of a bottom structure of vehicle according to an embodiment of the disclosure. FIG. 2 is a cross-sectional view of the bottom structure of vehicle of FIG. 1 along a line A-A. FIG. 3 is a cross-sectional view of the bottom structure of vehicle of FIG. 1 taken along line BB. FIG. 4A is a cross-sectional view of the bottom structure of vehicle of FIG. 1 taken along line CC. FIG. 4B is a schematic view of a modified embodiment of FIG. 4A. FIG. 5 is a partial bottom view of a bottom structure of vehicle according to the embodiment. FIG. 6 is a cross-sectional view of a power unit housing of FIG. 5 along a line D-D. FIG. 7 is a cross-sectional view of the power unit housing of FIG. 5 along a line E-E. FIG. 8 is another partial bottom view of a bottom structure of vehicle according to the embodiment. In this embodiment, a bottom structure of vehicle 100 is, for example, a bottom structure used in ordinary passenger cars (not shown), but the disclosure is not limited thereto and may also be applied to other types of vehicles. A width direction X, a front/rear direction Y, and a up/down direction Z of vehicle in the drawings are not intended to limit the positional relationship of each component in the disclosure. In addition, it should be noted that in the following descriptions, unless otherwise specified, the rear and top are the directions indicated by the arrows in the front/rear direction Y and the up/down direction Z of vehicle; the front and bottom are the opposite directions of the previous ones; inside and outside are in terms of relative positions in the width direction X of vehicle, and the direction indicated by the arrows in the width direction X of vehicle is not intended to limit the inside or outside. Whenever possible, the same reference numerals are used in the drawings and description to refer to the same or similar parts. The bottom structure of vehicle 100 of this embodiment is described below with reference to FIG. 1 to FIG. 8.

Referring to FIG. 1, in this embodiment, the bottom structure of vehicle 100 includes a power unit housing 110. An upper surface of the power unit housing 110 is formed as a floor surface (as seen from the viewing angle of FIG. 1), and a side panel 111 is formed on a side portion of the power unit housing 110 in the width direction X of vehicle. The side panel 111 protrudes toward the width direction X of vehicle from the power unit housing 110. In addition, the power unit housing 110 includes a front seal portion FS disposed at a front-end portion in the front/rear direction Y of vehicle, and a rear seal portion RS disposed at a rear end portion. Specifically, the front seal portion FS and the rear seal portion RS are, for example, disposed along an edge portion of the power unit housing 110 and formed into a strip shape extending in the width direction X of vehicle, but the disclosure is not limited thereto. In addition, the front seal portion FS and the rear seal portion RS are set to have the same height in the up/down direction Z of vehicle.

It can be seen that in the bottom structure of vehicle 100 of this embodiment, the upper surface of the power unit housing 110 is formed as a floor surface, and thus requires a sealing surface capable of waterproofing to prevent water intrusion. By providing the front seal portion FS and the rear seal portion RS with equal heights at the front-end portion and the rear end portion of the power unit housing 110, it is possible to avoid a situation in which it is difficult to seal the power unit housing 110 during assembly due to unequal heights in the front/rear direction. Accordingly, the bottom structure of vehicle 100 of the embodiment is capable of well preventing water intrusion.

Furthermore, in this embodiment, the power unit housing 110 further includes a side seal portion SS disposed at a side end portion in the width direction X of vehicle. The side seal portion SS is disposed on the side panel 111, and the front seal portion FS, the side seal portion SS, and the rear seal portion RS are continuously connected. Specifically, the front seal portion FS, the side seal portion SS, and the rear seal portion RS are formed on the same plane to become a first sealing surface 112, and thus, the side panel 111 is formed on the same plane as the first sealing surface 112. In this way, it may be ensured that the front seal portion FS, the side seal portion SS, and the rear seal portion RS of equal heights may be uniformly subjected to a force to be effectively sealed during sealing. In addition, the provision of the seal portion continuously in a circle along the edge portion of the power unit housing 110 inhibits water from entering the floor surface. In addition, the side panel 111 serve to support the power unit housing 110 in addition to mounting the power unit housing 110 to a vehicle body skeleton (e.g., a side sill 120, etc.). Thus, when a side impact occurs, the side panel 111 inhibits the direct transmission of the load to the power unit housing 110.

Please refer to FIG. 2, FIG. 3, and FIG. 7. In this embodiment, the power unit housing 110 further includes a first storage portion 113 and a second storage portion 114. The second storage portion 114 is disposed further rearward than the first storage portion 113 in the front/rear direction Y of vehicle, and an upper surface of the second storage portion 114 is formed to be higher than an upper surface of the first storage portion 113 in the up/down direction Z of vehicle. Thus, the second storage portion 114 with a larger storage space may be used to place a battery unit (not shown), but the disclosure is not limited thereto. As shown in FIG. 3, the second storage portion 114 includes a flange portion 114a disposed on the side surface in the width direction X of vehicle, and the flange portion 114a and the first storage portion 113 are disposed at the same height in the up/down direction Z of vehicle. Furthermore, the flange portion 114a is joined to the side panel 111 in the width direction X of vehicle (as shown in FIG. 7). Therefore, the sealing surfaces of the first storage portion 113 and the side panel 111 are at the same height, so that the sealing is more reliable.

Please refer to FIG. 1 and FIG. 4A. In this embodiment, a side sill 120 is disposed on the outside of the side panel 111 in the width direction X of vehicle. As shown in FIG. 4A, the side sill 120 is, for example, a hollow structure formed by joining a hat-shaped outer component and a hat-shaped inner component in the width direction X of vehicle, and a bottom 122 of the side sill 120 in the up/down direction Z of vehicle may include a bottom of the outer component and a bottom of the inner component, but it may also include a one-piece component, and the disclosure is not limited thereto. Specifically, the bottom 122 of the side sill 120 includes a second sealing surface 122a disposed at the bottom of the inner component and a fixing surface 122b disposed at the bottom of the outer component. The second sealing surface 122a is located inside relative to the fixing surface 122b in the width direction X of vehicle, and at the upper in the up/down direction Z of vehicle. In this way, it is more difficult for water from the outside of the vehicle to enter the inside from low to high, and the second sealing surface 122a is disposed separately from the fixing surface 122b to improve precision in assembly.

Furthermore, the bottom 122 of the side sill 120 further includes a vertical wall 122c. The vertical wall 122c extends in the up/down direction Z of vehicle to connect the second sealing surface 122a and the fixing surface 122b. A reinforcing component 124 extending in the up/down direction Z of vehicle is disposed inside the side sill 120, and the vertical wall 122c is joined to a lower end portion of the reinforcing component 124. That is, in the viewing angle of the front/rear direction of vehicle (i.e., from the viewing angle of FIG. 4A), the vertical wall 122c is connected to the reinforcing component 124 in a straight line to strengthen the cross-sectional strength of the side sill 120, and also to avoid affecting the second sealing surface 122a and the fixing surface 122b.

Next, the side panel 111 is formed with a hollow closed cross-section CS below the side sill 120 in the up/down direction Z of vehicle. For example, an outer end portion of the side panel 111 in the width direction X of vehicle includes, for example, an upper frame and a lower frame, thus enclosing the closed cross-section CS, but it is also possible to form the closed cross-section CS in one piece, and the disclosure is not limited thereto. Furthermore, a lifting member 111a is disposed inside the closed cross-section CS. Compared to the lifting member 111a being disposed within the side sill 120, the closed cross-section CS disposed on the side panel 111 may suppress the height in the up/down direction Z of vehicle, which in turn may suppress the lifting member 111a bending. In addition, the fixing surface 122b of the side sill 120 is fixed to the side panel 111 through a fastening member FE, and the lifting member 111a is disposed close to the fastening member FE. Thus, the load during lifting may be borne by the fastening member FE and the side sill 120. The fastening member FE is, for example, a combination of a bolt as well as a sleeve, but may also be other appropriate fastening tools, and the disclosure is not limited thereto.

As shown in FIG. 4A, for example, the lifting member 111a is disposed inside the fastening member FE in the width direction X of vehicle. As shown in FIG. 4B, in a modified embodiment, a lifting member 111a′ may also be disposed outside the fastening member FE in the width direction X of vehicle, and the disclosure is not limited thereto.

Please refer to FIG. 1, FIG. 5, and FIG. 8, the following description is directed to a back side of the bottom structure of vehicle 100. The power unit housing 110 is, for example, a housing of an intelligent power unit (IPU), used to protect the intelligent power unit located therein. Furthermore, the power unit housing 110 is assembled below the vehicle body skeleton (partially shown). The vehicle body skeleton is formed by, for example, side sills 120, a front wall panel (a lower front wall panel 130 shown in FIG. 1, which is made of high-strength materials such as heat-treated materials), and a rear member 150 (FIG. 8). For example, the power unit housing 110 is installed on a floor beam, and then is installed on the side sill 120 through a connecting member (e.g., the side panel 111), and prevents water intrusion by sealing (the front seal portion FS, the side seal portion SS, and the rear seal portion, etc.) the vehicle body skeleton and the power unit housing 110. In addition, the power unit housing 110 and the vehicle body skeleton are connected by screws or bolts, for example, but the disclosure is not limited thereto.

Referring to FIG. 5, in this embodiment, the bottom structure of vehicle 100 also includes a lower front wall panel 130 and a front member 140. The lower front wall panel 130 is disposed in front of the power unit housing 110 in the front/rear direction Y of vehicle, and the front member 140 is disposed below the lower front wall panel 130 in the up/down direction Z of vehicle. The power unit housing 110 is provided with a front fixing portion 115 close to the front seal portion FS. The front fixing portion 115 may be provided in multiple or a single one, and the disclosure is not limited thereto. The front fixing portion 115 integrally fixes the power unit housing 110, the lower front wall panel 130, and the front member 140. In this way, it is possible to improve the joining strength of the power unit housing 110 by means of the lower front wall panel 130 which is more rigid, and the fixing ensures that the seal portion (the front seal portion FS) is pressed against the front wall panel to avoid peeling off.

Please refer to FIG. 6 for further explanation of the fixed structure. The power unit housing 110 further includes a front vertical wall 116 extending from the front of the front seal portion FS in the front/rear direction Y of vehicle toward the bottom in the up/down direction Z of vehicle. The front fixing portion 115 extends from the front vertical wall 116 toward the front in the front/rear direction Y of vehicle, is located below the front member 140 and the lower front wall panel 130 in the up/down direction Z of vehicle, and is fixed by a combination of bolts and sleeves in the up/down direction Z of vehicle, but the disclosure is not limited thereto. That is, the lower front wall panel 130, the front member 140, and the front fixing portion 115 are fixed in order from the top to the bottom in the up/down direction Z of vehicle. As a result, the front member 140 may be more firmly installed on the power unit housing 110.

Please refer to FIG. 5 and FIG. 7. In this embodiment, the front fixing portion 115 includes a first front fixing portion 115a and a second front fixing portion 115b. The functions and fixing methods of the first front fixing portion 115a and the second front fixing portion 115b are the same, and the difference is only in the placement position. Specifically, the first front fixing portion 115a is formed at the outer end portion in the width direction X of vehicle, and the second front fixing portion 115b is formed at a position away from the first front fixing portion 115a in the width direction X of vehicle, i.e., disposed at an inner position compared to first front fixing portion 115a. Since the first front fixing portion 115a and the second front fixing portion 115b are far away from each other, in addition to suppressing a number of fixing portions to be disposed, a piping member P may be further disposed between the first front fixing portion 115a and the second front fixing portion 115b. In detail, the piping member P extends substantially in the front/rear direction Y of vehicle, is disposed below the side panel 111 in the up/down direction Z of vehicle (as shown in FIG. 7), and passes between the first front fixing portion 115a and the second front fixing portion 115b. The piping member P includes wire harnesses, brake piping, three-phase wires, etc., but not all wires pass between the first front fixing portion 115a and the second front fixing portion 115b, and some wires pass between the second front fixing portions 115b (close to a central side of the width direction X of vehicle), and the disclosure is not limited thereto.

Referring to FIG. 8, in this embodiment, a rear suspension component 50 is disposed behind the power unit housing 110 in the front/rear direction Y of vehicle and disposed below in the up/down direction Z of vehicle. The rear suspension component 50 includes a mounting portion 52 mounted on opposite sides of the vehicle body (not shown) in the width direction X of vehicle to fix the rear suspension component 50. The power unit housing 110 overlaps the mounting portion 52 of the rear suspension component 50 in the width direction X of vehicle. That is, a width of the power unit housing 110 extends to the vicinity of the rear suspension component 50, thereby ensuring a capacity space for placing the battery unit.

Furthermore, a rear member 150 is formed behind the power unit housing 110 in the front/rear direction Y of vehicle. The rear member 150 extends in the width direction X of vehicle. The mounting portion 52 of the rear suspension member 50 and a rear fixing portion 117 formed at the rear of a lower surface of the power unit housing 110 are fixed to the rear member 150. In this way, the power unit housing 110 is fixed to the rear member 150 to which the rear suspension member 50 is fixed, which may further improve the support rigidity of the power unit housing 110. For example, the rear fixing portion 117 may be provided in multiple or a single one, and the disclosure is not limited thereto.

In summary, in the bottom structure of vehicle of this embodiment, the upper surface of the power unit housing is formed as a floor surface, and thus requires a sealing surface capable of waterproofing to prevent water intrusion. By providing the front seal portion and the rear seal portion with equal heights at the front-end portion and the rear end portion of the power unit housing, a more reliable sealing performance may be achieved. In addition, the side panel is formed on a side portion of the power unit housing, and the seal portion is continuously disposed along the edge portion of the power unit housing and the side panel. In this way, in addition to ensuring that water does not intrude, the side panel is capable of mounting and supporting the power unit housing to the vehicle body skeleton (e.g., side sill, etc.). Accordingly, the bottom structure of vehicle of the disclosure is capable of preventing water intrusion.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A bottom structure of vehicle, comprising a power unit housing, wherein
an upper surface of the power unit housing is formed as a floor surface, and
the power unit housing comprises a front seal portion disposed at a front-end portion as well as a rear seal portion disposed at a rear end portion, wherein
the front seal portion and the rear seal portion are disposed at a same height in an up/down direction of vehicle.

2. The bottom structure of vehicle according to claim 1, wherein
the power unit housing further comprises a side seal portion disposed at a side end portion,
the front seal portion, the side seal portion, and the rear seal portion are continuously connected and formed on a same plane to become a first sealing surface.

3. The bottom structure of vehicle according to claim 2, wherein
a side panel is formed on a side portion of the power unit housing, and the side panel and the first sealing surface are formed in a same plane, and
the side seal portion is disposed on the side panel.

4. The bottom structure of vehicle according to claim 3, wherein
the power unit housing further comprises a first storage portion and a second storage portion, the second storage portion is disposed further rearward than the first storage portion in a front/rear direction of vehicle, and an upper surface of the second storage portion is formed to be higher than an upper surface of the first storage portion in the up/down direction of vehicle,
the second storage portion comprises a flange portion, the flange portion and the first storage portion are disposed at a same height in the up/down direction of vehicle, and
the flange portion is joined to the side panel.

5. The bottom structure of vehicle according to claim 3, wherein
a side sill is disposed on the outside of the side panel in a width direction of vehicle,
a bottom of the side sill in the up/down direction of vehicle comprises a second sealing surface and a fixing surface, the second sealing surface is located inside relative to the fixing surface in the width direction of vehicle, and at the upper in the up/down direction of vehicle.

6. The bottom structure of vehicle according to claim 5, wherein
the bottom of the side sill further comprises a vertical wall extending in the up/down direction of vehicle to connect the second sealing surface and the fixing surface, and
a reinforcing component is disposed inside the side sill, and the vertical wall is joined to a lower end portion of the reinforcing component.

7. The bottom structure of vehicle according to claim 5, wherein
the side panel is formed with a hollow closed cross-section below the side sill in the up/down direction of vehicle, and
a lifting member is disposed inside the closed cross-section.

8. The bottom structure of vehicle according to claim 7, wherein
the fixing surface of the side sill is fixed to the side panel through a fastening member, and
the lifting member is disposed close to the fastening member.

9. The bottom structure of vehicle according to claim 2, further comprising:
a lower front wall panel disposed in front of the power unit housing in a front/rear direction of vehicle; and
a front member disposed below the lower front wall panel in the up/down direction of vehicle, wherein
the power unit housing is provided with a front fixing portion close to the front seal portion, and the front fixing portion integrally fixes the power unit housing, the lower front wall panel, and the front member.

10. The bottom structure of vehicle according to claim 9, wherein
the power unit housing further comprises a front vertical wall extending from the front of the front seal portion in the front/rear direction of vehicle toward the bottom in the up/down direction of vehicle, the front fixing portion extends from the front vertical wall toward the front in the front/rear direction of vehicle, and
the front fixing portion is located below the front member and the lower front wall panel in the up/down direction of vehicle.

11. The bottom structure of vehicle according to claim 9, wherein
the front fixing portion comprises a first front fixing portion and a second front fixing portion,
the first front fixing portion is formed at an outer end portion in a width direction of vehicle, and the second front fixing portion is formed at a position away from the first front fixing portion in the width direction of vehicle, and
a piping member is disposed between the first front fixing portion and the second front fixing portion.

12. The bottom structure of vehicle according to claim 2, wherein
a rear suspension component is disposed behind the power unit housing in a front/rear direction of vehicle and disposed below in the up/down direction of vehicle,
the rear suspension component comprises a mounting portion mounted on opposite sides of a vehicle body in a width direction of vehicle, and
the power unit housing overlaps the mounting portion of the rear suspension component in the width direction of vehicle.

13. The bottom structure of vehicle according to claim 12, wherein
a rear member is formed behind the power unit housing in the front/rear direction of vehicle, and the rear member extends in the width direction of vehicle, and
the mounting portion of the rear suspension component and a rear fixing portion formed at the rear of a lower surface of the power unit housing are fixed to the rear member.
